(19) United States
(12) Patent Application Publication
(10) Pub. No.: US 2009/0301878 A1
(43) Pub. Date: Dec. 10, 2009

(54) AMMONIA SENSOR ELEMENT, METHOD OF MAKING THEREOF, AND AMMONIA SENSOR DERIVED THEREFROM

(76) Inventors: Da Yu Wang, Troy, MI (US); Carlos A. Valdes, Flint, MI (US); Walter T. Symons, Grand Blanc, MI (US); Robert J. Farhat, Grosse Pointe Park, MI (US); Sheng Yao, Macomb, MI (US); Mustafa U. Unuvar, Flint, MI (US); David K. Chen, Rochester Hills, MI (US); David D. Cabush, Kokomo, IN (US)

Correspondence Address: CANTOR COLBURN, LLP, 20 Church Street, 22nd Floor, Hartford, CT, 06103, US

(21) Appl. No.: 12/133,962

(22) Filed: Jun. 5, 2008

(51) Int. Cl. G01N 27/407; B05D 5/12

(52) U.S. Cl. 204/429; 427/58

(57) ABSTRACT

Disclosed herein is an ammonia sensor element comprising an ammonia selective sensor electrode, a reference electrode, a solid electrolyte in ionic communication with the ammonia selective sensor electrode and the reference electrode, and a protective layer disposed on the ammonia selective sensor electrode, comprising a porous portion comprising an ammonia-inert material. A method of making an ammonia gas sensor element comprises disposing an ammonia selective sensor electrode on and in ionic communication with a solid electrolyte, disposing a reference electrode on and in ionic communication with the solid electrolyte, and disposing a protective layer comprising a porous portion comprising an ammonia-inert material on the ammonia selective sensor electrode.

### BACKGROUND

This disclosure generally relates to an ammonia sensor element, a method of making thereof, and an ammonia sensor derived therefrom.

During the operation of an internal combustion engine, some undesirable pollutants can be generated. Non-limiting examples of these undesirable pollutants include nitrogen oxides (NOx), unburnt hydrocarbons (HC), carbon monoxide (CO), and the like. Various pollution-control after treatment devices are generally use to minimize, reduce, and/or eliminate the generation of the undesirable pollutants, and/or to minimize, reduce, and/or eliminate the release of the undesirable pollutants into the atmosphere. Non-limiting examples of after treatment devices include a three-way catalytic converter, and a selective catalytic reduction (SCR) catalyst, which can reduce and/or oxidize NOx, CO, and/or HC. The NOx reduction can be accomplished by using ammonia gas, which is generally supplied by a urea tank.

In order to avoid pollution breakthrough, an effective feedback control loop utilizing an ammonia sensor is generally required. One group of ammonia sensor designs operate based on the non-equilibrium Nernst Principle, where the sensor converts chemical energy from ammonia into electromotive force (emf). The sensor can measure this emf to determine the partial pressure of ammonia in a sample gas. However, the performance of the sensor can be altered by the presence of one or several poisons. Non-limiting examples of such poisons include materials such as silicon dioxide, lead oxide, alkali metal oxides, alkaline earth metal oxides, sulfur dioxide, metal phosphate glass, soot, and the like.

In some gas sensors, a non-limiting example of which includes oxygen gas (O₂) sensors, a protective layer is used in order to alleviate the adverse effects of the poisons. Non-limiting examples of such protective layers include aluminum oxide, doped aluminum oxide (e.g., lanthanum doped aluminum oxide), spinel, cordierite, and the like. However, the foregoing protective layers result in adverse effects when used in conjunction with an ammonia sensor, because they can catalyze the reaction of ammonia with O₂ and/or NOx, for example, before ammonia can reach the ammonia selective sensor electrode, thus altering the emf signal output of the ammonia sensor. The adverse effects can be due to the use of acidic or basic binders in order to form the protective layers, such as, but not limited to, aluminum nitrate, and the like. The adverse effects can also be due to a combination of the material used to form the protective layer, and the binder used for the same.

Therefore, there exists a need for materials and binders that can be advantageous for use as protective layers and/or coatings in ammonia sensing devices, while simultaneously effectively reducing and/or inhibiting the reaction of ammonia before ammonia can be sensed.

### SUMMARY

The above-described and other drawbacks are alleviated by an ammonia sensor element comprising an ammonia selective sensor electrode, a reference electrode, a solid electrolyte in ionic communication with the ammonia selective sensor electrode and the reference electrode, and a protective layer disposed on the ammonia selective sensor electrode, comprising a porous portion comprising an ammonia-inert material.

In another embodiment, a method of making an ammonia gas sensor element comprises disposing an ammonia selective sensor electrode on and in ionic communication with a solid electrolyte, disposing a reference electrode on and in ionic communication with the solid electrolyte, and disposing a protective layer comprising a porous portion comprising an ammonia-inert material on the ammonia selective sensor electrode.

### BRIEF DESCRIPTION OF THE DRAWINGS

Referring now to the drawings wherein like elements are numbered alike in several FIGURES:

FIG. 1 is an exploded view of an exemplary ammonia sensor element;

FIG. 2 is a partial cross-sectional view of an exemplary ammonia sensor;

FIG. 3 is a graphical representation of emf values over time resulting from an ammonia sensor lacking a protective layer;

FIG. 4 is a graphical representation of emf values over time resulting from an ammonia sensor lacking a protective layer after a 6 hour exposure to SiO₂ poison;

FIG. 5 is a graphical representation of emf values over time resulting from an ammonia sensor with a traditional alumina protective layer after a 6 hour exposure to SiO₂ poison;

FIG. 6 is a graphical representation of emf values over time resulting from an ammonia sensor with a boron nitride protective layer after a 6 hour exposure to SiO₂ poison;

FIG. 7 is a graphical representation of emf values over time resulting from an ammonia sensor with a SiO₂ based glass protective layer having a surface area of 250 m²/g after a 6 hour exposure to SiO₂ poison;

FIG. 8 is a graphical representation of emf values over time resulting from an ammonia sensor with a SiO₂ based glass protective layer having a surface area of 300 m²/g after a 6 hour exposure to SiO₂ poison; and

FIG. 9 is a graphical representation of emf values over time resulting from an ammonia sensor with an alumina powder coated with SiO₂ protective layer after a 6 hour exposure to SiO₂ poison.

### DETAILED DESCRIPTION

Surprisingly, the present inventors have discovered that an ammonia sensor element comprising an ammonia selective sensor electrode, a reference electrode, a solid electrolyte in ionic communication with the ammonia selective sensor electrode and the reference electrode, and a protective layer disposed on the ammonia selective sensor electrode, comprising a porous portion comprising an ammonia-inert material, is effective at providing accurate ammonia concentration readings, while preventing and/or slowing down the poisoning of the ammonia sensor element. The porous portion is generally disposed on the ammonia selective sensor electrode, and provides for fluid communication between the ammonia selective sensor electrode and ammonia gas when exposed to a gas stream comprising ammonia gas. The porous portion is also effective at trapping an ammonia sensor element poison when exposed to a gas stream comprising the poison.

It is to be understood that a “poison”, as used herein, refers to a material that can adversely affect the ammonia sensor element if allowed to block and/or hinder the ammonia sensing process, by, for example, accumulating on the surface of the electrode, or on the surface of the electrolyte, and/or by blocking the pores of the same, and/or by changing the chemical structure of the same. Therefore, a material, such as, but not limited to, SiO₂, can be advantageous to use as a binder in the manufacture of the electrode, however, can be disadvantageous as a poison if allowed to accumulate uncontrollably on the surface of, for example, the electrolyte layer and/or the electrode, and/or to clog the porous structures of the same.

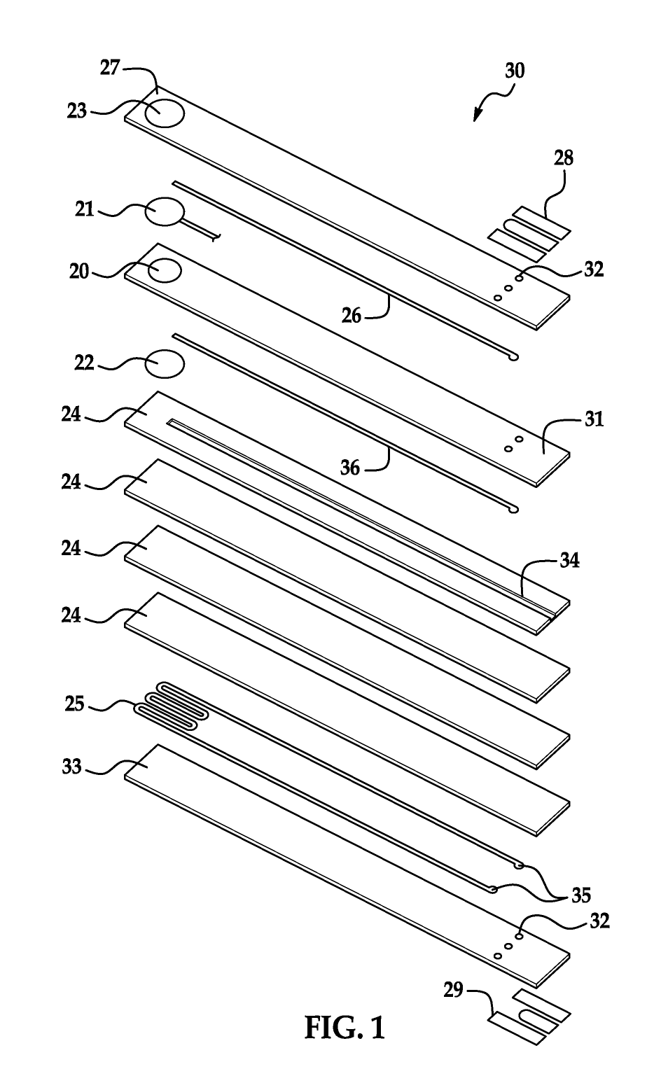

Referring now to FIG. 1, an exploded view of an exemplary ammonia sensor element 30 is shown. It is to be understood that although the invention is described in relation to a flat plate sensor, other two and three dimensional sensor designs can also be employed, such as conical, cylindrical, and the like.

The ammonia sensor element 30 comprises an ammonia selective sensor electrode 21 and a reference electrode 22 disposed on opposite sides of a solid electrolyte 20. Other configurations are suitable, such as, but not limited to, the ammonia selective sensor electrode 21 and the reference electrode 22 being disposed on the same side of the solid electrolyte 20. The reference electrode 22 is generally in fluid communication with a gas having a predetermined ammonia concentration or with ambient air. In one embodiment, the reference electrode 22 can also be in fluid communication with a gas being monitored or tested for its ammonia content, referred to herein as the sensing gas. The ammonia selective sensor electrode 21 is generally in fluid communication with the sensing gas under operational conditions.

Therefore, when the concentration of ammonia is not zero, an output voltage can be generated between the electrodes. The output voltage is a function of the partial pressures of ammonia in the sensing gas, as well as the temperature of the electrolyte 20. In the embodiment where the reference electrode 22 is also in fluid communication with the sensing gas, the reference electrode 22 comprises a material that can catalytically equilibrate ammonia with O₂, leaving no ammonia on the reference electrode's electrochemically active area. Non-limiting examples of materials that can catalytically equilibrate ammonia with O₂ include palladium, platinum, and the like. In such an embodiment, the ammonia activity difference between the two electrodes produces the emf. The ammonia selective sensor electrode 21 generally comprises a material that is selectively sensitive to ammonia, while being less sensitive to NOx, CO, and HC. In one embodiment, the ammonia selective sensor electrode 21 is slightly sensitive to gases other than ammonia. In another embodiment, the ammonia selective sensor electrode 21 is slightly sensitive to NOx while not being sensitive to other gases.

The ammonia sensor element 30 further comprises a protective layer 27 having a porous portion 23, which provides for fluid communication (e.g., through diffusion) between the sensing gas and the ammonia selective sensor electrode 21. The ammonia selective sensor electrode 21 is in electrical communication with one or several of vias 32 through sensor lead 26. The protective layer 27 is disposed between contact pads 28 and sensor lead 26. On the side of the ammonia selective sensor electrode 21 opposite the protective layer 27, an electrolyte layer 31 is disposed, comprising the solid electrolyte 20. On a side of the reference electrode 22, opposite the electrolyte layer 31, is disposed a reference gas channel 34 (and/or a chamber (not shown) for reference gas) in fluid communication with the reference channel. In one embodiment where the sensing gas is also used as the reference gas, the channel 34 can open (e.g., to the side) to access the sensing gas. One or more insulating layers 24 are disposed between the reference electrode and associated reference lead 22/36 and a heater 25. Optionally, a temperature sensor (not shown) can be disposed between layers 24 for control of the heater 25, and/or a ground plane (not shown) can be disposed therebetween. The heater 25, which is disposed in thermal communication with the sensing end of the sensor (i.e., the end comprising the electrodes 21, 22), can be advantageously located between the insulating layers 25 and a heater protective layer 33. On the outside of the ammonia sensor element 30, on a side of the heater protective layer 33, are contact pads 29 in electrical communication with vias 32 that are in electrical communication with the heater leads 35.

The ammonia selective sensor electrode 21 comprises any ammonia selective material compatible with the operating environment, that is, any ammonia selective material capable of sensing ammonia at the operating conditions, such as temperature, pressure, and the like. Non-limiting examples of ammonia selective materials include vanadium and oxides of vanadium (e.g., V, V₂O₅), tungsten and oxides of tungsten (e.g., W, WO₃), molybdenum and oxides of molybdenum (e.g., Mo, MoO₃), and combinations thereof. In one embodiment, the ammonia selective material is selected from V₂O₅, WO₃, MoO₃, and combinations thereof. In one advantageous embodiment, the ammonia selective material is V₂O₅.

The ammonia selective materials can be doped with other electrically conductive metals, which also includes their oxides. Non-limiting examples of the other electrically conductive metals that can be used include Bi, Cu, Ca, Sr, Sn, Pb, Sb, Nb, Ta, Cr, La, Mg, Gd, Nd, Sm, Ba, and combinations thereof. Non-limiting examples of their oxides include Bi₂O₃, CuO, CaO, SrO, SnO, PbO, Sb₂O₃, Nb₂O₅, Ta₂O₅, CrO₃, La₂O₃, MgO, Gd₂O₃, Nd₂O₃, Sm₂O₃, BaO, and combinations of the foregoing materials.

The ammonia selective materials can also be doped with a chemically stabilizing metal (including the oxide), which can be the same as or different from the other electrically conductive metal and/or metal oxide. The chemically stabilizing metal can, inter alia, help eliminate the green effect. Non-limiting examples of the chemically stabilizing metal include Nb, Ta, Mg, and the like, as well as combinations thereof.

The ammonia selective materials can also be doped with a diffusion impeding dopant (including the oxide). The diffusion impeding dopant can, among other things, inhibit poisoning of the electrode by contaminants. Non-limiting examples of diffusion impeding dopants include Zn, Fe, Zr, Pb, Y, and the like, as well as combinations thereof.

In one embodiment, a combination of other electrically conductive metals, chemically stabilizing metals, and diffusion impeding dopants can be used.

The chemically stabilizing metals, can be present in an amount of about 0.1 to about 5 at. %. The diffusion impeding dopants and the chemically stabilizing metals can be collectively present in an amount of about 0.1 at. % to about 5 at. %. Specifically, the collective amount of the chemically stabilizing metals and the diffusion impeding dopants is about 0.3 to about 3 at. %, and even more specifically about 0.5 to about 1 at. %, based on the total atoms in the ammonia selective sensor electrode.

The formulation for the ammonia selective sensor electrode 21 can be formed in advance of deposition onto the electrolyte 20 or can be disposed on the electrolyte 20 and formed during the firing of the sensor. For example, a layer of an ammonia selective sensor electrode formulation can be disposed on the electrolyte 20 using any suitable method available to one with ordinary skill in the art such as, but not limited to, spraying, painting, dip coating, screen printing, laminating, and the like. The layer comprises the ammonia selective material (i.e., V, W, Mo, V₂O₅, WO₃, MoO₃, or the like, or combinations thereof), and optionally the other conducting metal/oxide (e.g., Bi, Pb, La, Sr, Ca, Cu Gd, Nd, Y, Sm, and/or the like), the chemically stabilizing metal(s) (e.g., Mg, Ta, and/or the like), and diffusion-impeding dopants (e.g., Zr, Fe, Zn, Pb, Y, and/or the like). When the sensor is fired, the foregoing compounds react to form the ammonia selective sensor electrode 21.

In one advantageous embodiment, the ammonia selective sensor electrode formulation is first prepared and then disposed on the electrolyte (or the layer adjacent the electrolyte). Thus, the ammonia selective material, advantageously in the form of an oxide, can be combined with the other metal dopants (or their oxides) simultaneously or sequentially. The materials are well mixed to facilitate the doping process, and are then fired at a suitable firing temperature to produce the ammonia selective sensor electrode material.

In one exemplary embodiment, the ammonia selective sensor electrode material comprises V₂O₅ doped with Bi (or Bi₂O₃). Thus, V₂O₅ is mixed with Bi₂O₃ by, for example, milling, and then fired to produce BiVO₄. In another exemplary embodiment, V₂O₅ is mixed with Bi₂O₃ and Ta₂O₅ by milling for about 2 to about 24 hours. The mixture is fired at about 800° C. to about 900° C. for a period of time to effect the doping of Bi and Ta into the vanadium oxide structure to produce BiTaₓV₁₋ₓO_{4-y}, wherein x is less than about 0.5 specifically about 0.0001 to about 0.4, more specifically about 0.001 to about 0.3, and even more specifically about 0.01 to about 0.2, and y is the difference in the value between the stoichiometric amount of oxygen and the actual amount. In one exemplary embodiment, y is 0.05. The period of time for firing the mixture is dependent upon the specific temperature and the particular materials being fired, and can be readily determined by one with ordinary skill in the art. In general, the period of time for firing the mixture is about 0.5 hours to about 24 hours.

The ammonia selective sensor electrode material can be disposed on the solid electrolyte 20 using any suitable deposition technique, such as, but not limited to, spraying, painting, dip coating, screen printing, laminating, and the like. In one exemplary embodiment, screen printing is used, wherein the ammonia selective sensor electrode material is formed into an ink. The ink can comprise, in addition to the ammonia selective sensor electrode material, a binder, a carrier, a wetting agent, a solvent, a fugitive material, and the like, and combinations comprising at least one of the foregoing. The binder can be any material capable of providing adhesion between the ink and the substrate. Non-limiting examples of binders include acrylic resin, acrylonitrile, styrene, poly(acrylic acid), poly(methacrylic acid), poly(methyl acrylate), poly(methyl methacrylate), and the like, as well as combinations comprising at least one of the foregoing binders. Carriers include any material suitable for imparting desired printing and drying characteristics of the ink. Non-limiting examples of carriers include volatile solvents that can dissolve polymer resins such as butyl acetate. Non-limiting examples of wetting agents include ethanol, isopropyl alcohol, methanol, cetyl alcohol, calcium octoate, zinc octoate and the like, as well as combinations comprising at least one of the foregoing.

The different constituents of the ink can be present in different amounts depending on the nature of the materials, and the product, and can be readily determined by a person with ordinary skill in the art. In general, the binder can be present in about 1 to about 40 percent by weight (wt. %), the carrier can be present in about 1 to about 40 wt. %, the wetting agent can be present in about 1 to about 20 wt. %, and the ammonia selective material can be present in about 15 to about 98 wt. %, based on the total weight of the ink.

In one embodiment, the ink comprises about 10 to about 30 wt. % of 1-methoxy-2-propanol acetate, about 10 to about 30 wt. % butyl acetate, about 5 to about 10 wt. % acrylic resin, 0.1 to about 5 wt. % poly(methyl methacrylate), about 5 to about 10 wt. % ethanol, and about 30 to about 60 wt. % of the ammonia selective material, based on the total weight of the ink.

Fugitive materials are used in the ink formulations to produce a desired porosity in the final electrodes, that is, a sufficient porosity to enable the ammonia to enter the electrode and reach triple points (points where the electrode, electrolyte, and ammonia meet to enable the desired reactions). Fugitive materials are materials that degrade leaving voids upon firing. Some non-limiting examples of fugitive materials include graphite, carbon black, starch, nylon, polystyrene, latex, other soluble organics (e.g., sugars and the like), and the like, as well as combinations comprising one or more of the foregoing fugitive materials. The fugitive material can be present in an amount of about 0.1 to about 20 wt. %, based on the total weight of the ink.

The reference electrode 22 can comprise any electrode material, that is, the reference electrode 22 can be sensitive or insensitive to ammonia. The reference electrode 22 can comprise any metal and/or metal catalyst capable of producing an electromotive force across the solid electrolyte 20 when the ammonia selective sensor electrode 21 is in contact with ammonia. Non-limiting examples of the foregoing metals and/or metal catalysts include platinum, palladium, gold, osmium, rhodium, iridium, ruthenium, zirconium, yttrium, cerium, calcium, aluminum, and the like, as well as alloys, oxides, and combinations comprising at least one of the foregoing. In one advantageous embodiment, the reference electrode 22 comprises platinum, which exhibits an elevated processing temperature, and is readily available commercially as an ink.

With respect to the size and geometry of the sensing and reference electrodes 21, 22, they are generally adequate to provide current output sufficient to effect a reasonable signal resolution over a wide range of ammonia concentrations. Generally, a thickness of about 1 micrometer (μm) to about 25 μm can be employed, more specifically a thickness of about 5 μm to about 20 μm, and with a thickness of about 10 μm to about 18 μm being advantageous. In one advantageous embodiment, the geometry of the electrodes is substantially similar to the geometry of the solid electrolyte.

The electrodes can be formed using any suitable technique such as chemical vapor deposition, screen printing, sputtering, and stenciling, among others, with screen printing onto appropriate tapes being advantageous due to simplicity, economy, and compatibility with the subsequent firing process. For example, reference electrode 22 can be screen printed onto support layer 24 or under the solid electrolyte 20, and the ammonia selective sensor electrode 21 can be screen printed under porous protective layer 23 or over the solid electrolyte 20.

Electrode leads 26, 36 (as well as heater leads) and vias 32 in the layers 27, 31, 33 are typically formed simultaneously with the electrodes. In one embodiment, if the ammonia sensor element 30 is not co-fired (i.e., all of the green or unfired layers laid up to form the green sensor, and the green sensor then fired to form the final sensor), the vias 32 and leads 26, 36 can be formed separately from the electrodes 21, 22. In this embodiment, when the electrodes 21, 22 comprise materials that cannot be heated to the firing temperatures without degrading the electrodes 21, 22, the electrodes 21, 22 can be screen printed onto the fired layer, and then fired at a lower temperature.

Although the porosity of reference electrode 22 is generally sufficient to hold an adequate quantity of ammonia to act as a reference, a space for storing reference ammonia (not shown) can be provided between reference electrode 22 and adjoining support layer 24. This space can be formed by depositing a fugitive material between the reference electrode 22 and the adjacent insulating layer such that upon processing the fugitive material burns out leaving a void. Alternatively, reference electrode 22 can be in fluid communication with a point external to the sensor allowing reference gas access to the reference electrode via channel 34 as shown in FIG. 1.

The solid electrolyte 20 can comprise the entire layer 31 or a portion thereof. The solid electrolyte 20 can be any material that is capable of permitting the electrochemical transfer of ions while inhibiting the physical passage of exhaust gases, and is compatible with the environment in which the ammonia sensor element 30 will be utilized. The solid electrolyte 20 is in ionic communication with the ammonia selective sensor electrode 21 and the reference electrode 22. Non-limiting examples of solid electrolyte materials include metal oxides such as zirconia, and the like, which can optionally be stabilized with calcium, barium, yttrium, magnesium, aluminum, lanthanum, cerium, gadolinium, and the like, and oxides thereof, as well as combinations comprising at least one of the foregoing electrolyte materials. Generally, the electrolyte has a thickness of about 25 to about 500 μm, specifically about 25 to about 500 μm. In one advantageous embodiment, the thickness of the solid electrolyte is about 50 to about 200 μm.

The solid electrolyte 20 can be formed using any method available to one with ordinary skill in the art including, but not limited to, doctor blade slurry casting, die pressing, roll compaction, stenciling, screen printing, and the like. In one advantageous embodiment, the solid electrolyte 20 is formed using a tape process utilizing any suitable ceramic tape casting method. If the solid electrolyte 20 comprises a portion of the electrolyte layer 31, a stamping method can also be used whereby the solid electrolyte 20 is disposed into an opening in the electrolyte layer 31 or attached onto an end of the electrolyte layer 31.

The protective layer 27 comprises a porous portion 23 that has a sufficient porosity to allow the ammonia to diffuse therethrough, while protecting the ammonia selective sensor electrode 21 from abrasion, particulates, poisoning, and the like. The porous portion 23 can comprise the entire protective layer 27 or a portion thereof. The porous portion 23 can comprise any ammonia-inert material that is also advantageous as dielectric, insulating, and/or protective material and will not adversely affect the ammonia sensor element 30.

In one embodiment, the ammonia-inert materials do not react with ammonia. In another embodiment, the ammonia-inert materials do not catalyze the reaction of ammonia with O₂ and/or NOx. In one advantageous embodiment, the ammonia-inert materials do not react with ammonia and do not catalyze the reaction of ammonia with O₂ and/or NOx.

The ammonia-inert materials generally comprise a high surface area that is effective at trapping poisons carried by the sensing gas prior to the poisons contacting the ammonia selective sensor electrode 21. The surface area of the ammonia-inert materials and/or of the porous portion 23 can be about 5 to about 1000 squared meters per gram (m²/g). In one embodiment, the surface area is about 50 to about 900 m²/g. In another embodiment, the surface area is about 100 to about 800 m²/g.

Non-limiting examples of ammonia-inert materials include metal and non-metal borides, nitrides, carbides, and silicides, SiO₂ (crystalline and amorphous), and SiO₂ based glass (generally comprising greater than about 50 wt. % SiO₂). Non-limiting examples of borides include boron rich metal borides (ratio of B:metal greater than or equal to 4:1) such as LaB₆, and the like, and boron poor metal borides (ratio of B:metal less than 4:1) such as AlB₂, TiB₂, and the like. Non-limiting examples of nitrides include Si₃N₄, BN, GaN, and the like. Non-limiting examples of carbides include SiC, TiC, WC, and the like. Non-limiting examples of silicides include WSi₂, ZrSi₂, TiSi₂, and the like. In one exemplary embodiment, the ammonia-inert material is BN. In another exemplary embodiment, the ammonia-inert material is SiO₂ based glass.

Metal oxides that are otherwise disadvantageous for use herein, can be used when their surface is coated with a thin layer of the above ammonia-inert materials. Not wishing to be bound by theory, but it is believed that the foregoing metal oxides can react with ammonia, or can catalyze the reaction of ammonia with O₂ or with NOx. Coating the metal oxides with the ammonia-inert material alleviates the foregoing adverse reactions. Non-limiting examples of the metal oxides include Al₂O₃, spinel, alkali metal oxides, alkaline earth metal oxides, transition metal oxides, lanthanide oxides, actinide oxides, In₂O₃, Sb₂O₃, and the like, and combinations thereof. In one advantageous embodiment, the metal oxide coated with a thin layer of the ammonia-inert materials comprises alumina coated with a silica glass.

The thin layer of the ammonia-inert materials can disposed on the metal oxides using any suitable method available to one with ordinary skill in the art such as, but not limited to, chemical vapor deposition, dip coating, spin coating, physical vapor deposition, plasma coating, and the like.

As with the electrolyte layer 31, the porous portion 23 of the protective layer 27 (or the protective layer 27 if the porous portion 23 comprises the entire protective layer 27) can be formed using ceramic tape casting methods or other methods such as plasma spray deposition techniques, screen printing, stenciling, spray coating, painting, dip coating, laminating, chemical vapor deposition, physical vapor deposition, spin coating, and the like. The ammonia-inert materials can be formed into a powder, a slurry, an ink, or the like, prior to deposition.

When used as slurry or ink, the slurry or ink can comprise, in addition to the ammonia-inert materials, a binder, a carrier, a wetting agent, and/or a fugitive material. The binders used in conjunction with the ammonia-inert materials are also ammonia-inert. These ammonia-inert binders can include any of the ammonia-inert materials, with the proviso that they have a melting point less than or equal to about 1000° C., a softening point less than or equal to about 1000° C., or a combination thereof. The melting point and/or the softening point of the ammonia-inert binder is specifically about 100 to about 900° C., more specifically about 200 to about 800° C., more specifically about 300 to about 700° C., and even more specifically about 400 to about 600° C. In one advantageous embodiment, the ammonia-inert binder comprises 7052 glass, commercially available from Corning Inc., which is a borosilicate glass having a softening point of about 400° C.

Non-limiting examples of carriers, wetting agents, and fugitive materials include the above described in the above described amounts, with the proviso that they do not adversely affect the ammonia gas sensor element. After the formation of the porous portion 23, the sensor element is fired at a temperature and for a time efficient at activating the ammonia-inert materials, burning off fugitive materials, binders, and the like, while advantageously not causing any adverse effects that can cause a substantial reduction in the performance of the ammonia gas sensor element. Generally, this can be effected by firing at about 500° C. to about 800° C. for about one half to about 6 hours.

The protective layer and/or the porous portion 23 can have a thickness of up to about 200 μm, with a thickness of about 50 to about 200 μm being advantageous.

Disposed on a side of the reference electrode 22, opposite the electrolyte 20, can be one or more insulating layers 24, and a heater protective layer 33. These layers comprise materials that effectively protect various portions of the ammonia sensor element 30, provide structural integrity, and separate various components. Heater protective layer 33 electrically isolates the heater 25 from the sensor circuits, while support layers 24 physically separate the reference electrode 22 and heater 25. Advantageously, these layers comprise alumina or similar insulating materials that are compatible with the electrolyte and the operating environment, and which are chosen to at least minimize, if not eliminate, delamination and other processing problems.

The insulating layers 24 and protective layer 33 can each be up to about 200 μm thick, depending on the number of layers employed, with a thickness of about 50 to about 200 μm being advantageous. As with the electrolyte layer 31, these layers can be formed using ceramic tape casting methods or other methods such as plasma spray deposition techniques, screen printing, stenciling and the like.

Disposed between the insulating layers 24 and the heater protective layer 33, is the heater 25, with a ground plane (not shown) and/or a temperature sensor (not shown) optionally disposed between two other substrate layers. The heater 25 can be any heater capable of maintaining a sensor end of ammonia sensor element 30 at a sufficient temperature to facilitate the various electrochemical reactions therein. The heater, which can comprise platinum, palladium, aluminum, or the like, alloys thereof, or combinations comprising at least one of the foregoing, or any other heater compatible with the environment, is generally screen printed onto a substrate to a thickness of about 5 to about 50 μm.

Leads 26, 35, 36 are disposed across various dielectric layers to electrically connect the external wiring of ammonia sensor element 30 with electrodes 21, 22. Leads are typically formed on the same layer as the electrode and heater to which they are in electrical communication and extend from the electrode/heater to the terminal end of the element (i.e., the end opposite the sensing end) where they are in electrical communication with the corresponding via 32.

At the terminal end of sensor element, vias 32 are formed as holes through protective layer 33 filled with electrically conductive material in the appropriate layers or can be a hole at the end of the layer providing electrical communication through the layer. Vias are typically filled during formation of electrodes/heater 21, 22, 25 and leads 26, 35, 36, and serve to provide a mechanism for electrically connecting leads 25, 35, 36 to contact pads 28, 29 on the exterior of ammonia sensor element 30. The contact pads 28, 29 provide contact points for providing the output of element 30 to the external sensor circuit, as well as power to heater 25, respectively.

The disclosed ammonia sensor elements can be manufactured using bulk ceramic technology, thick-film multi-layer technology, or thin-film multi-layer technology, among others. In bulk ceramic technology, the sensor elements are formed in a suitable shape such as a cup shape by traditional ceramic processing methods with the electrodes deposited by ink methods (e.g., screen printing) and/or plasma methods. During formation, the respective electrodes, leads, heater(s), optional ground plane(s), optional temperature sensor(s), vias, and the like, are disposed onto the appropriate layers. The layers are laid-up accordingly (e.g., as illustrated in FIG. 1), and then fired at temperatures of about 1,400° C. to about 1,500° C. Alternatively, the electrodes are not disposed onto the layers. The green layers (including the leads, optional ground plane(s), optional temperature sensor(s), vias, and the like) are fired at temperatures sufficient to sinter the layers, e.g., temperatures of about 1,400° C. to about 1,500° C. The electrodes are then disposed on the appropriate fired layer(s), and the layers are laid-up accordingly. The sensor element is then again fired at a temperature sufficient to activate the electrode materials, e.g., temperatures of about 700° C. to about 850° C.

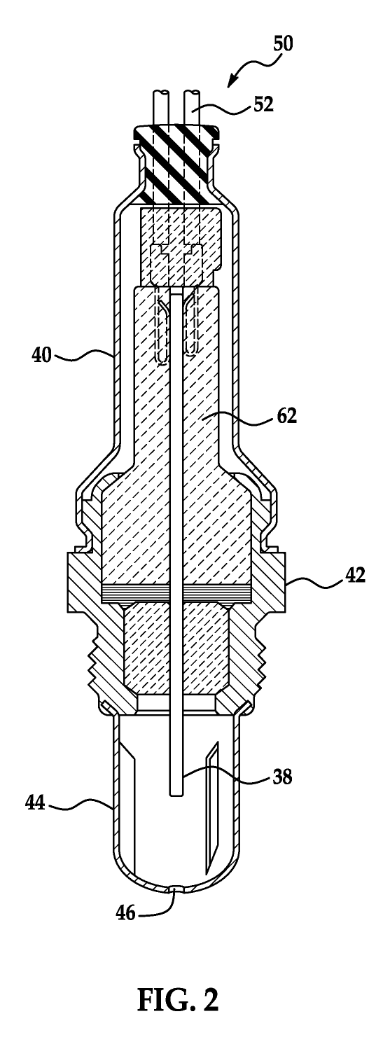

Referring now to FIG. 2, a partial cross-sectional view of an exemplary ammonia sensor 50 is shown, which comprises ammonia sensor element 38 disposed therein. It is to be understood that although the invention is described in relation to an ammonia sensor, it relates to any sensor where ammonia sensing can be advantageous, such as sensors for pollution monitoring and control in ambient air, indoors or outdoors, sensors in medical and agricultural applications, and the like.

The ammonia sensor 50 comprises ammonia sensor element 38, an upper shell 40, a lower shell 42, and a lower shield 44. The sintered ammonia sensor element 38 extends from the upper shell 40, through the lower shell 42, and into the lower shield 44. The lower shield 44 has opening(s) 46 to enable fluid communication between the sensing end of the sintered ammonia sensor element 38 and the sensing gas. To provide structural integrity to the ammonia sensor element 38, insulators 62 (e.g., ceramic, talc, mesh (metal or other), and/or the like) are disposed between the sintered ammonia sensor element 38 and the shell 40, 42. The terminal end of the ammonia sensor element 38 is disposed within upper shell 40 in electrical commutation with a terminal interface such that cables 52 can be disposed in electrical communication with the ammonia sensor element 38 via the contact pads.

During operation, the ammonia sensor 50 is disposed in an area where a gas is to be sensed (e.g., within an exhaust conduit of a vehicle). When a gas passes down the conduit, the gas enters the ammonia sensor 50 through opening 46 and contacts the sintered ammonia sensor element 38. The gases pass through the porous portion 23 where they contact the ammonia selective sensor electrode 21. Due to the ammonia concentration at the ammonia selective sensor electrode 21 and the insensitivity to the ammonia at the reference electrode 22, ammonia concentration is detected in the gas stream as a function of the emf output of sensor 30. The ammonia concentration can be fed into an analyzer. Based on the ammonia concentration, the amount of ammonia and/or urea, and/or the air to fuel ratio of the exhaust stream can be adjusted to attain the desired emissions.

The ammonia gas sensor element disclosed herein can be used in an ammonia gas sensor as disclosed above. However, it is not limited to ammonia gas sensors, and can be used wherever ammonia gas sensing is advantageous. The ammonia gas sensor element can be used in sensors such as, but not limited to, NOx sensors, CO sensors, HC sensors, and the like.

The invention is further illustrated by the following non-limiting examples.

### COMPARATIVE EXAMPLE 1

An ammonia sensor element comprising an ammonia selective sensor electrode, a reference electrode, a solid electrolyte, and a heater was used in this example. The ammonia selective sensor electrode comprised BiVO₄ doped with 4 mole % of MgO. The reference electrode comprised platinum. The solid electrolyte comprised yttria stabilized zirconia. No protective layer was used.

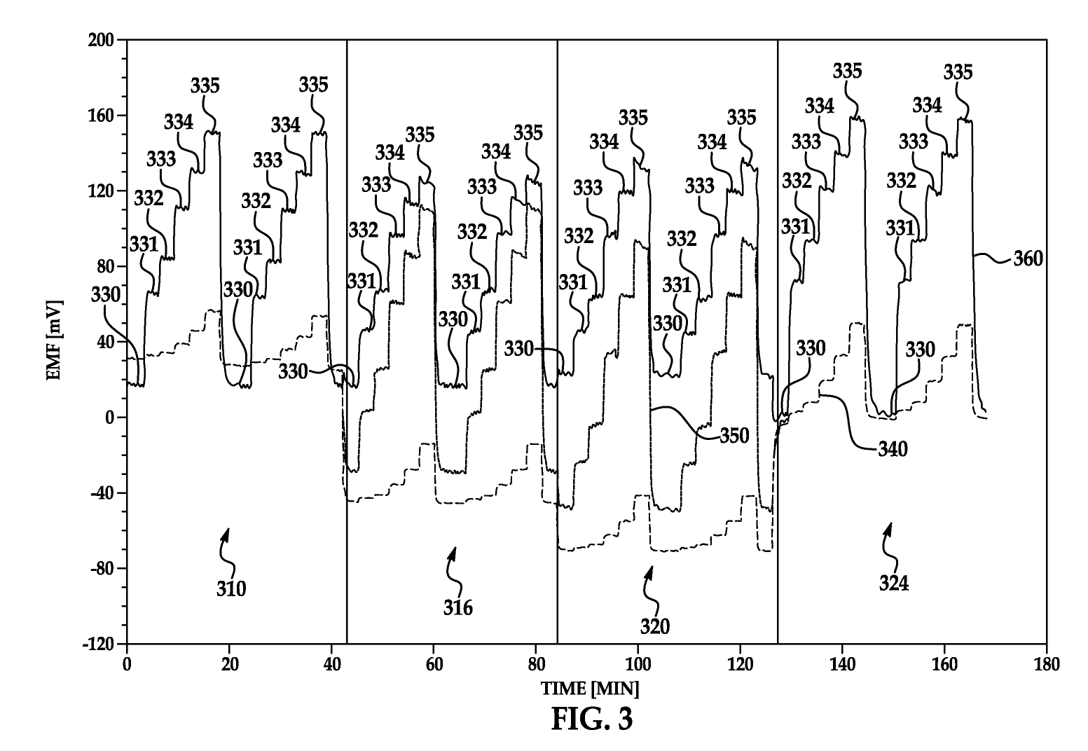

The freshly produced ammonia sensor element was used to detect ammonia under an atmosphere comprising 10.5% by volume oxygen and 1.5% by volume H₂O, the balance being nitrogen. The results are shown in FIG. 3, which is a graphical representation of emf values over time. Four different levels of NOx were used, and two sensing cycles were performed for every different level of NOx. The first level of NOx in section 310 was 200 ppm NO and 0 ppm NO₂, the second level of NOx in section 316 was 100 ppm NO and 100 ppm NO₂, the third level of NOx in section 320 was 0 ppm NO and 200 ppm NO₂, and the forth level of NOx in section 324 was 0 ppm NO and 0 ppm NO₂, that is, 0 ppm NOx.

Each sensing cycle was used to sense a concentration of ammonia starting at 0 ppm, then 5, 10, 25, 50, and 100 ppm, which correspond respectively to 330-335 in the graph. The sensor included a NOx sensing cell to correct for the NOx emf sensed by the ammonia selective sensor electrode. Curve 340 (long dashed line) is the NOx emf, curve 350 (short dashed line) is the sensed ammonia emf, while curve 360 (solid line) is the corrected ammonia emf. The corrected emf values for the sensed ammonia concentration for each cycle in sections 310, 316, 320, and 324 can be found in Table 1.

TABLE 1

| | | | Ammonia Concentration (ppm) | | | | | |
|---|---|---|---|---|---|---|---|---|
| | | | 0 | 5 | 10 | 25 | 50 | 100 |
| | | | Corrected Sensed Ammonia emf (mV) | | | | | |
| Composition of NOx | 200/0 | cycle 1 | 17 | 66 | 83 | 110 | 130 | 150 |
| (NO/NO₂ ppm) | | cycle 2 | 16 | 63 | 82 | 110 | 130 | 150 |
| | 100/100 | cycle 1 | 17 | 46 | 66 | 97 | 112 | 125 |
| | | cycle 2 | 18 | 46 | 67 | 97 | 115 | 125 |
| | 0/200 | cycle 1 | 23 | 45 | 62 | 96 | 119 | 131 |
| | | cycle 2 | 21 | 43 | 63 | 95 | 120 | 133 |
| | 0/0 | cycle 1 | 2 | 72 | 93 | 121 | 139 | 158 |
| | | cycle 2 | 1 | 73 | 92 | 121 | 136 | 157 |

| | | | | | | |
|---|---|---|---|---|---|---|
| Mean emf (mV) | 14.38 | 56.75 | 76.00 | 105.88 | 125.13 | 141.13 |
| Std. deviation (biased) | 7.74 | 12.14 | 12.12 | 10.40 | 9.33 | 13.15 |
| Std. deviation (unbiased) | 8.28 | 12.98 | 12.96 | 11.12 | 9.98 | 14.06 |

It can be seen from FIG. 3 and Table 1 that the freshly produced ammonia sensor element produced consistent results for the corrected ammonia emf under the varying levels of NOx. The standard deviations, biased and unbiased, were between 7.74 and 14.06 for the mean emf values for the corrected ammonia emf.

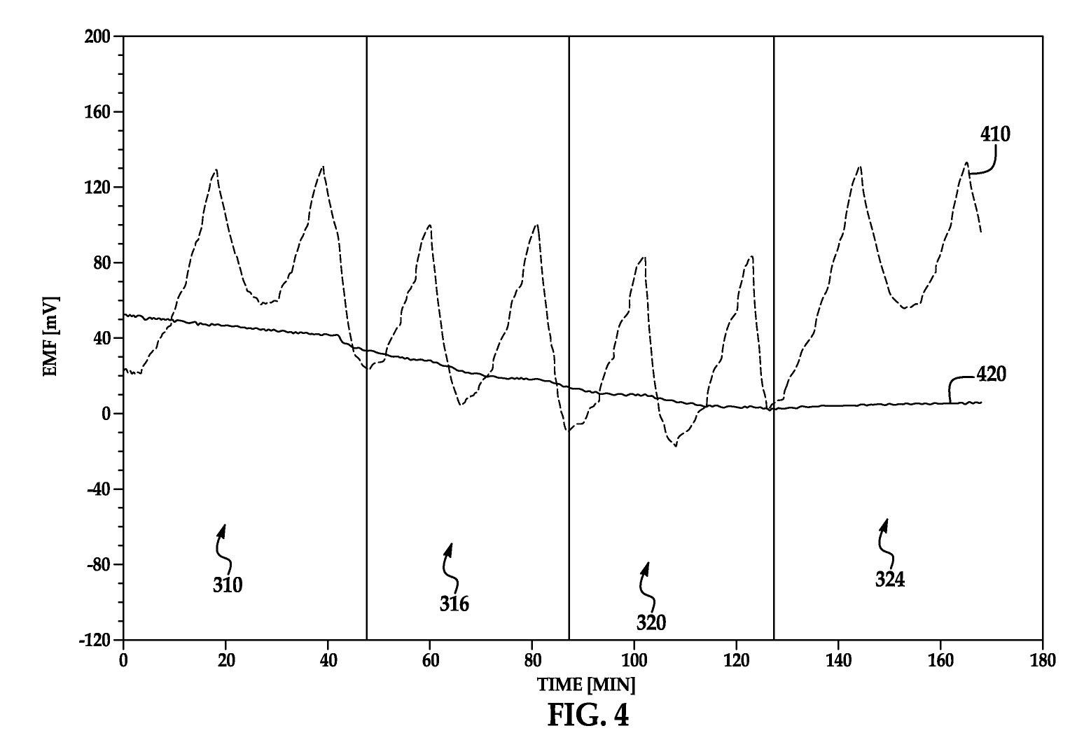

The ammonia sensor element used in FIG. 3 was exposed to SiO₂ poison for 6 hours. FIG. 4 shows the results of the ammonia using the same conditions of gas concentration as used in FIG. 3. Curve 410 (dashed line) is an overlap of the sensed ammonia emf and the corrected ammonia emf, while curve 420 (solid line) is the NOx emf. It can be seen from FIG. 4 that the sensing ability displayed in FIG. 3 is quickly diminished due to SiO₂ poisoning when no protective layer is present. The emf values could not be reliably or accurately determined, and the sensed and corrected ammonia emf values register as being the same.

### COMPARATIVE EXAMPLE 2

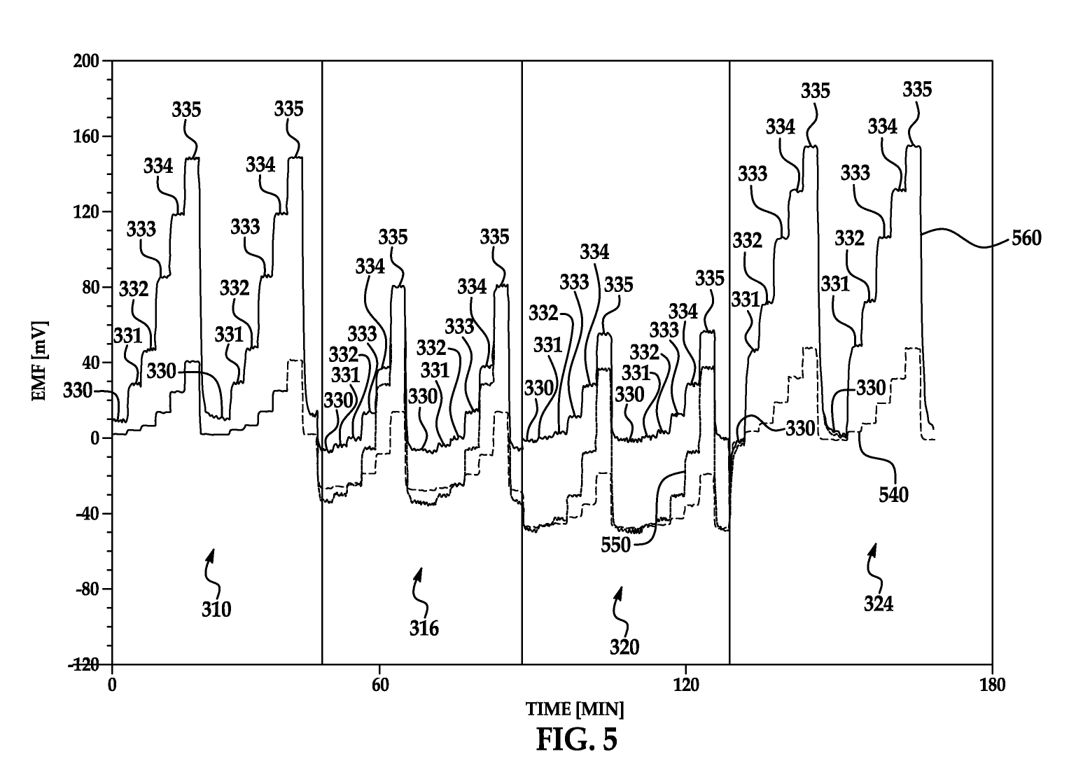

An ammonia sensor element according to Comparative Example 1 was used herein, however, a protective layer was used, which was a traditional exhaust oxygen sensor type of coating comprising Al₂O₃ and using aluminum nitrite as the binding agent. The results of ammonia sensing after a six hour exposure to SiO₂ poison are shown in FIG. 5. Curve 540 (long dashed line) is the NOx emf, curve 550 (short dashed line) is the sensed ammonia emf, while curve 560 (solid line) is the corrected ammonia emf. The corrected emf values for the sensed ammonia concentration for each cycle in sections 310, 316, 320, and 324 can be found in Table 2.

TABLE 2

| | | | Ammonia Concentration (ppm) | | | | | |
|---|---|---|---|---|---|---|---|---|
| | | | 0 | 5 | 10 | 25 | 50 | 100 |
| | | | Corrected Sensed Ammonia emf (mV) | | | | | |
| Composition of NOx | 200/0 | cycle 1 | 10 | 29 | 47 | 85 | 118 | 149 |
| (NO/NO₂ ppm) | | cycle 2 | 10 | 30 | 48 | 85 | 119 | 149 |
| | 100/100 | cycle 1 | −7 | −4 | 0 | 13 | 38 | 79 |
| | | cycle 2 | −8 | −5 | 1 | 14 | 38 | 80 |
| | 0/200 | cycle 1 | −1 | 1 | 3 | 11 | 28 | 53 |
| | | cycle 2 | −1 | 0 | 3 | 12 | 29 | 56 |
| | 0/0 | cycle 1 | 0 | 44 | 71 | 105 | 131 | 154 |
| | | cycle 2 | 1 | 49 | 72 | 105 | 130 | 154 |

| | | | | | | |
|---|---|---|---|---|---|---|
| Mean emf (mV) | 0.50 | 18.00 | 30.63 | 53.75 | 78.88 | 109.25 |
| Std. deviation (biased) | 6.26 | 21.00 | 30.11 | 41.86 | 45.95 | 43.21 |
| Std. deviation (unbiased) | 6.70 | 22.45 | 32.19 | 44.75 | 49.12 | 46.19 |

It can be seen from FIG. 5 and Table 2 that while the traditional alumina layer can be useful in alleviating SiO₂ poisoning, the corrected ammonia signal for the same ammonia concentration is substantially different under varying levels of NOx, even though the sensing cycles were performed under the same levels of ammonia as above. In this case, the corrected emf values produced when the NO and NO₂ concentrations are 100 ppm each, and when the NO₂ concentration is 200 ppm, are substantially smaller than when the concentration of NO is 200 ppm or when the NOx concentration is 0 ppm. This variation results in a substantial standard deviations associated with the mean emf values. The standard deviations were as high as 49.12, and were between 21.00 and 49.12 at ammonia concentrations between 5 and 100 ppm.

### EXAMPLE 1

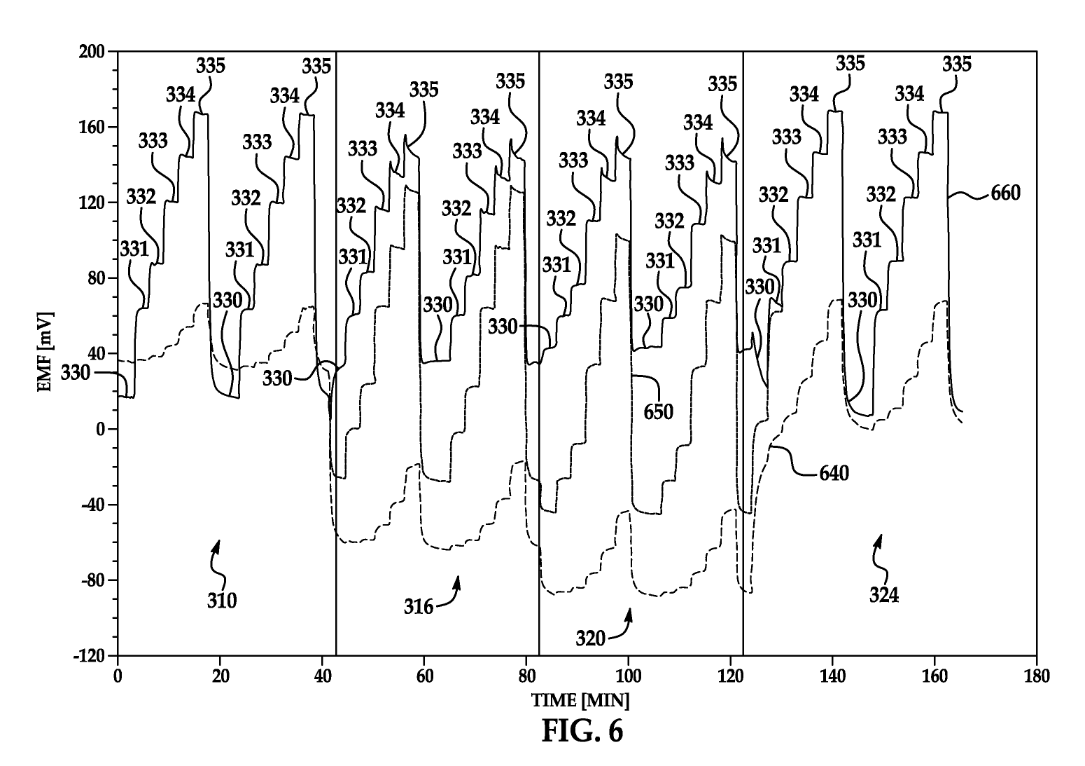

An ammonia sensor element according to Comparative Example 1 was used herein, however, a protective layer comprising a porous portion comprising boron nitride as the ammonia-inert material was disposed on the ammonia selective sensor electrode. The boron nitride was spray coated as an aerosol along with 2 wt. % of a SiO₂ based glass binder. This was fired in air at 800° C. for 1 hour. The results of ammonia sensing after a six hour exposure to SiO₂ poison are shown in FIG. 6. Curve 640 (long dashed line) is the NOx emf, curve 650 (short dashed line) is the sensed ammonia emf, while curve 660 (solid line) is the corrected ammonia emf. The corrected emf values for the sensed ammonia concentration for each cycle in sections 310, 316, 320, and 324 can be found in Table 3.

TABLE 3

| | | | Ammonia Concentration (ppm) | | | | | |
|---|---|---|---|---|---|---|---|---|
| | | | 0 | 5 | 10 | 25 | 50 | 100 |
| | | | Corrected Sensed Ammonia emf (mV) | | | | | |
| Composition of NOx | 200/0 | cycle 1 | 17 | 63 | 87 | 120 | 143 | 165 |
| (NO/NO₂ ppm) | | cycle 2 | 18 | 60 | 86 | 120 | 142 | 165 |
| | 100/100 | cycle 1 | 31 | 59 | 82 | 117 | 142 | 152 |
| | | cycle 2 | 36 | 60 | 80 | 116 | 139 | 152 |
| | 0/200 | cycle 1 | 42 | 60 | 78 | 110 | 138 | 154 |
| | | cycle 2 | 42 | 59 | 74 | 109 | 135 | 152 |
| | 0/0 | cycle 1 | 22 | 68 | 86 | 122 | 145 | 167 |
| | | cycle 2 | 7 | 62 | 89 | 122 | 148 | 168 |

| | | | | | | |
|---|---|---|---|---|---|---|
| Mean emf (mV) | 26.88 | 61.38 | 82.75 | 117.00 | 141.50 | 159.38 |
| Std. deviation (biased) | 12.00 | 2.83 | 4.82 | 4.77 | 3.84 | 6.96 |
| Std. deviation (unbiased) | 12.83 | 3.02 | 5.15 | 5.10 | 4.11 | 7.44 |

It can be seen from FIG. 6 and Table 3 that the boron nitride layer is effective at alleviating SiO₂ poisoning, and that the corrected ammonia emf produced at varying NOx levels is very similar under the same NH₃ concentration. This is reflected in the low and consistent standard deviations associated with the mean emf values. For example, while the standard deviation for 0 ppm ammonia was relatively higher, the standard deviations for 5 ppm to 100 ppm ammonia ranged from 2.83 to 6.96, which is substantially better than in Comparative Example 2.

In addition, a plot of the corrected ammonia concentration (not shown) corresponds substantially to a plot of the actual ammonia concentration (not shown).

### EXAMPLE 2

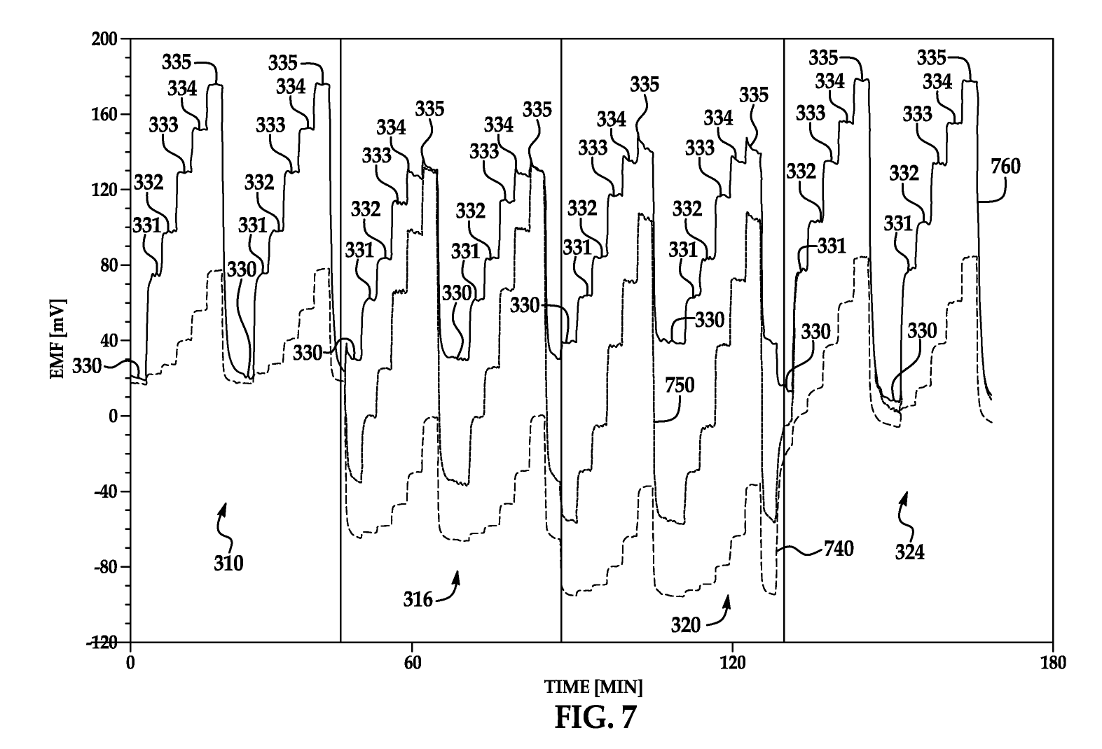

An ammonia sensor element according to Comparative Example 1 was used herein, however, the porous portion of the protective layer comprised SiO₂ based glass having a surface area of 250 m²/g. The SiO₂ based glass comprises 64 wt. % SiO₂, 19 wt. % Bi₂O₃, 8 wt. % Al₂O₃, 3 wt. % BaO and K₂O, 2 wt. % Na₂O, and 1 wt. % Li₂O. The SiO₂ based glass was applied by dip coating as a slurry comprising 75 wt. % of the SiO₂ based glass in powder form, 5 wt. % carbon black, and 20 wt. % of alkali barium borosilicate glass powder. This was fired at 700° C. for 1.5 hours. The results of ammonia sensing after a six hour exposure to SiO₂ poison are shown in FIG. 7. Curve 740 (long dashed line) is the NOx emf, curve 750 (short dashed line) is the sensed ammonia emf, while curve 760 (solid line) is the corrected ammonia emf. The corrected emf values for the sensed ammonia concentration for each cycle in sections 310, 316, 320, and 324 can be found in Table 4.

TABLE 4

| | | | Ammonia Concentration (ppm) | | | | | |
|---|---|---|---|---|---|---|---|---|
| | | | 0 | 5 | 10 | 25 | 50 | 100 |
| | | | Corrected Sensed Ammonia emf (mV) | | | | | |
| Composition of NOx | 200/0 | cycle 1 | 20 | 75 | 98 | 129 | 151 | 175 |
| (NO/NO₂ ppm) | | cycle 2 | 20 | 75 | 99 | 130 | 152 | 176 |
| | 100/100 | cycle 1 | 30 | 62 | 82 | 113 | 131 | 137 |
| | | cycle 2 | 30 | 61 | 83 | 113 | 130 | 133 |
| | 0/200 | cycle 1 | 40 | 63 | 84 | 118 | 140 | 149 |
| | | cycle 2 | 39 | 62 | 83 | 118 | 136 | 150 |
| | 0/0 | cycle 1 | 17 | 78 | 103 | 137 | 158 | 180 |
| | | cycle 2 | 9 | 79 | 103 | 135 | 156 | 178 |

| | | | | | | |
|---|---|---|---|---|---|---|
| Mean emf (mV) | 25.63 | 69.38 | 91.88 | 124.13 | 144.25 | 159.75 |
| Std. deviation (biased) | 10.23 | 7.50 | 9.03 | 9.12 | 10.59 | 18.31 |
| Std. deviation (unbiased) | 10.94 | 8.02 | 9.66 | 9.75 | 11.32 | 19.58 |

It can be seen from FIG. 7 and Table 4 that the SiO₂ based glass having a surface area of 250 m²/g layer is effective at alleviating SiO₂ poisoning, and that the corrected ammonia emf produced at varying NOx levels is very similar under the same NH₃ concentration. This is reflected in the low and consistent standard deviations associated with the mean emf values. For example, while the standard deviation for 100 ppm ammonia was relatively higher, the standard deviations for 0 ppm to 50 ppm ammonia ranged from 7.50 to 11.32, which is substantially better than in Comparative Example 2.

In addition, a plot of the corrected ammonia concentration (not shown) corresponds substantially to a plot of the actual ammonia concentration (not shown).

### EXAMPLE 3

An ammonia sensor element according to Example 2 was used herein, however, the SiO₂ based glass was applied using screen printing. Similar results were obtained.

### EXAMPLE 4

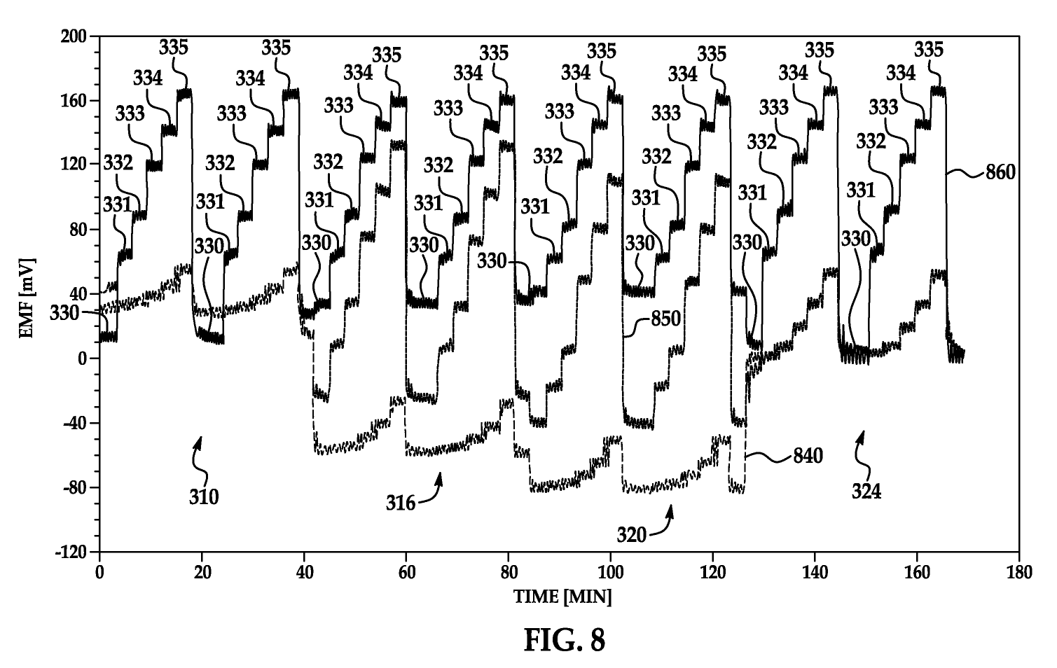

An ammonia sensor element according to Example 2 was used herein, however, the porous portion of the protective layer comprised SiO₂ based glass having a surface area of 300 m²/g. The SiO₂ based glass was applied by dip coating as a slurry comprising 10 wt. % of alkali barium borosilicate glass powder as binder. This was fired at 700° C. for 1.5 hours. The results of ammonia sensing after a six hour exposure to SiO₂ poison are shown in FIG. 8. Curve 840 (long dashed line) is the NOx emf, curve 850 (short dashed line) is the sensed ammonia emf, while curve 860 (solid line) is the corrected ammonia emf. The corrected emf values for the sensed ammonia concentration for each cycle in sections 310, 316, 320, and 324 can be found in Table 5.

TABLE 5

| | | | Ammonia Concentration (ppm) | | | | | |
|---|---|---|---|---|---|---|---|---|
| | | | 0 | 5 | 10 | 25 | 50 | 100 |
| | | | Corrected Sensed Ammonia emf (mV) | | | | | |
| Composition of NOx | 200/0 | cycle 1 | 12 | 63 | 88 | 120 | 141 | 162 |
| (NO/NO₂ ppm) | | cycle 2 | 13 | 63 | 88 | 120 | 141 | 162 |
| | 100/100 | cycle 1 | 30 | 63 | 89 | 121 | 144 | 160 |
| | | cycle 2 | 31 | 62 | 87 | 121 | 143 | 160 |
| | 0/200 | cycle 1 | 41 | 62 | 81 | 119 | 145 | 163 |
| | | cycle 2 | 40 | 62 | 80 | 118 | 144 | 162 |
| | 0/0 | cycle 1 | 19 | 65 | 89 | 122 | 146 | 164 |
| | | cycle 2 | 4 | 66 | 90 | 122 | 145 | 164 |

| | | | | | | |
|---|---|---|---|---|---|---|
| Mean emf (mV) | 23.75 | 63.25 | 86.50 | 120.38 | 143.63 | 162.13 |
| Std. deviation (biased) | 12.84 | 1.39 | 3.57 | 1.32 | 1.73 | 1.45 |
| Std. deviation (unbiased) | 13.73 | 1.49 | 3.82 | 1.41 | 1.85 | 1.55 |

It can be seen from FIG. 8 that the SiO₂ based glass having a surface area of 300 m²/g layer is effective at alleviating SiO₂ poisoning, and that the corrected ammonia emf produced at varying NOx levels is very similar under the same NH₃ concentration. This is reflected in the low and consistent standard deviations associated with the mean emf values. For example, while the standard deviation for 0 ppm ammonia was relatively higher, the standard deviations for 5 ppm to 100 ppm ammonia ranged from 1.39 to 3.82, which is substantially better than in Comparative Example 2.

In addition, a plot of the corrected ammonia concentration (not shown) corresponds substantially to a plot of the actual ammonia concentration (not shown).

### EXAMPLE 5

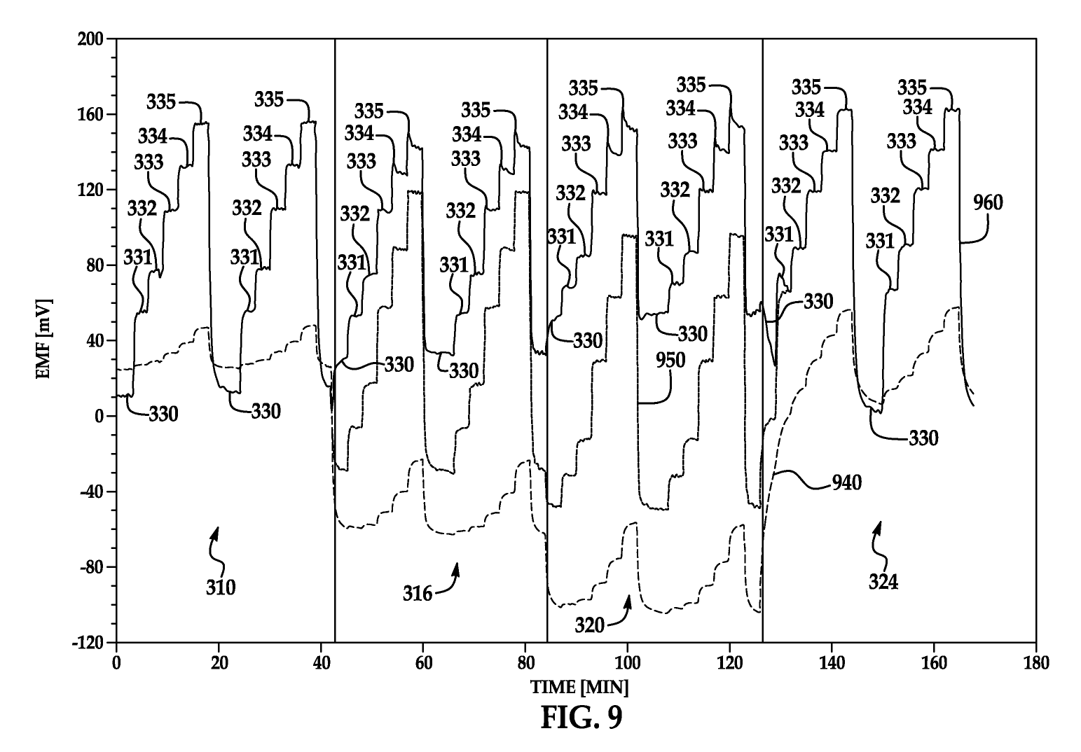

An ammonia sensor element according to Comparative Example 1 was used herein, however, the porous portion of the protective layer comprised alumina powder coated with SiO₂. The alumina powder contained 50 wt. % α-alumina and 50 wt. % γ-alumina. The SiO₂ coating was applied using chemical vapor deposition. The SiO₂ coated alumina powder was applied by dip coating using 5 wt. % of alkali barium borosilicate glass powder as binder. This was fired at 700° C. in air for 1.5 hours. The results of ammonia sensing after a six hour exposure to SiO₂ poison are shown in FIG. 9. Curve 940 (long dashed line) is the NOx emf, curve 950 (short dashed line) is the sensed ammonia emf, while curve 960 (solid line) is the corrected ammonia emf. The corrected emf values for the sensed ammonia concentration for each cycle in sections 310, 316, 320, and 324 can be found in Table 6.

TABLE 6

| | | | Ammonia Concentration (ppm) | | | | | |
|---|---|---|---|---|---|---|---|---|
| | | | 0 | 5 | 10 | 25 | 50 | 100 |
| | | | Corrected Sensed Ammonia emf (mV) | | | | | |
| Composition of NOx | 200/0 | cycle 1 | 10 | 54 | 76 | 110 | 132 | 155 |
| (NO/NO₂ ppm) | | cycle 2 | 11 | 55 | 78 | 110 | 133 | 155 |
| | 100/100 | cycle 1 | 27 | 52 | 74 | 110 | 132 | 150 |
| | | cycle 2 | 33 | 53 | 75 | 110 | 132 | 150 |
| | 0/200 | cycle 1 | 50 | 67 | 85 | 118 | 143 | 161 |
| | | cycle 2 | 53 | 69 | 88 | 120 | 144 | 162 |
| | 0/0 | cycle 1 | 30 | 72 | 88 | 120 | 141 | 163 |
| | | cycle 2 | 10 | 68 | 91 | 122 | 142 | 163 |

| | | | | | | |
|---|---|---|---|---|---|---|
| Mean emf (mV) | 28.00 | 61.25 | 81.88 | 115.00 | 137.38 | 157.38 |
| Std. deviation (biased) | 16.11 | 7.90 | 6.39 | 5.10 | 5.19 | 5.22 |
| Std. deviation (unbiased) | 17.22 | 8.45 | 6.83 | 5.45 | 5.55 | 5.58 |

It can be seen from FIG. 9 and Table 6 that the alumina powder coated with SiO₂ layer is effective at alleviating SiO₂ poisoning, and that the corrected ammonia emf produced at varying NOx levels is very similar under the same NH₃ concentration. This is reflected in the low and consistent standard deviations associated with the mean emf values. For example, while the standard deviation for 0 ppm ammonia was relatively higher, the standard deviations for 5 ppm to 100 ppm ammonia ranged from 2.83 to 6.96, which is substantially better than in Comparative Example 2.

In addition, a plot of the corrected ammonia concentration (not shown) corresponds substantially to a plot of the actual ammonia concentration (not shown).

The present ammonia gas sensor elements are advantageous due to the protective coating comprising the porous section comprising ammonia-inert materials and binders. They provide the ammonia selective sensor electrodes with resistance to poisons, while improving the sensing capabilities of the sensor element by alleviating the adverse effects of catalyzing the reaction of ammonia. They are economical to manufacture and to operate.

This written description uses figures in reference to exemplary embodiments and examples to disclose the invention, including the best mode, and also to enable any person skilled in the art to make and use the invention. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

All ranges disclosed herein are inclusive of the endpoints, and the endpoints are independently combinable with each other. Further, it is understood that disclosing a range is specifically disclosing all ranges formed from any pair of any upper range limit and any lower range limit within this range, regardless of whether ranges are separately disclosed. It is not intended that the scope of the invention be limited to the specific values recited when defining a range.

The use of the terms “a” and “an” and “the” and similar referents in the context of describing the invention (especially in the context of the following claims) are to be construed to cover both the singular and the plural, unless otherwise indicated herein or clearly contradicted by context. Further, it should further be noted that the terms “first,” “second,” and the like herein do not denote any order, quantity, or importance, but rather are used to distinguish one element from another. The modifier “about” used in connection with a quantity is inclusive of the stated value and has the meaning dictated by the context (e.g., it includes the degree of error associated with measurement of the particular quantity).

As used herein, “in fluid communication” refers to a structural relationship between elements, which permits conveyance of fluid therebetween and does not necessarily imply the presence of a fluid. The term “fluid” as used herein refers to a liquid or, advantageously, gaseous material or a material which includes components which are liquid or, advantageously, gaseous, or both.

As used herein, “in ionic communication” refers to a relationship between elements, which permits the transfer of ions therebetween, and does not necessarily imply the presence of ions.

What is claimed is:

1. An ammonia sensor element, comprising:
an ammonia selective sensor electrode;
a reference electrode;
a solid electrolyte in ionic communication with the ammonia selective sensor electrode and the reference electrode; and
a protective layer disposed on the ammonia selective sensor electrode, comprising a porous portion comprising an ammonia-inert material.

2. The ammonia gas sensor element of claim 1, wherein the ammonia-inert material does not react with ammonia, does not catalyze the reaction of ammonia, or does not react with ammonia and does not catalyze the reaction of ammonia.

3. The ammonia gas sensor element of claim 1, wherein the ammonia-inert material comprises a boride, a nitride, a carbide, a silicide, crystalline SiO₂, amorphous SiO₂, SiO₂ based glass comprising greater than about 50 percent by weight SiO₂, a metal oxide coated with a thin layer of the foregoing, or a combination thereof.

4. The ammonia gas sensor element of claim 1, wherein the ammonia-inert material further comprises an ammonia-inert binder comprising a boride, a nitride, a carbide, a silicide, crystalline SiO₂, amorphous SiO₂, SiO₂ based glass comprising greater than about 50 percent by weight SiO₂, with the proviso that the ammonia-inert binder has a melting point, a softening point, or a combination thereof, of less than about 1000° C.

5. The ammonia gas sensor element of claim 1, wherein the surface area of the porous portion or the ammonia-inert material is about 5 to about 1000 squared meters per gram.

6. The ammonia sensor element of claim 1, wherein the porous portion is disposed on the ammonia selective sensor electrode.

7. The ammonia gas sensor element of claim 1, wherein the ammonia selective sensor electrode comprises an ammonia selective material comprising vanadium oxide, tungsten oxide, molybdenum oxide, or a combination thereof.

8. The ammonia gas sensor element of claim 7, wherein the ammonia selective material is doped with another electrically conductive metal, metal oxide, or a combination thereof.

9. The ammonia gas sensor element of claim 8, wherein the other conductive metal comprises bismuth, copper, calcium, strontium, tin, lead, antimony, niobium, tantalum, chromium, lanthanum, magnesium, gadolinium, neodymium, samarium, barium, or a combination thereof, and further wherein the other conductive metal oxide comprises bismuth oxide, copper oxide, calcium oxide, strontium oxide, tin oxide, lead oxide, antimony oxide, niobium oxide, tantalum oxide, chromium oxide, lanthanum oxide, magnesium oxide, gadolinium oxide, neodymium oxide, samarium oxide, barium oxide, or a combination thereof.

10. The ammonia gas sensor element of claim 9, wherein the ammonia selective material is further doped with a chemically stabilizing metal, a chemically stabilizing metal oxide, or a combination thereof.

11. The ammonia gas sensor element of claim 9, wherein the ammonia selective material is further doped with a diffusion impeding material.

12. The ammonia gas sensor element of claim 1, wherein the reference electrode comprises any metal capable of producing an electromotive force across the solid electrolyte when the ammonia selective sensor electrode is in contact with ammonia.

13. The ammonia gas sensor element of claim 12, wherein the reference electrode comprises platinum, palladium, gold, osmium, rhodium, iridium, ruthenium, zirconium, yttrium, cerium, calcium, aluminum, an alloy comprising at least one of the foregoing, an oxide comprising at least one of the foregoing, or a combination thereof.

14. The ammonia gas sensor element of claim 12, wherein the reference electrode comprises platinum.

15. The ammonia gas sensor element of claim 1, wherein the solid electrolyte comprises zirconia.

16. The ammonia gas sensor element of claim 15, wherein the zirconia is stabilized with yttria.

17. The ammonia sensor element of claim 1, wherein the porous portion is effective at trapping an ammonia selective sensor electrode poison when exposed to a gas stream comprising the ammonia selective sensor electrode poison.

18. The ammonia gas sensor element of claim 17, wherein the poison comprises silicon dioxide, lead oxide, an alkali metal oxide, an alkaline earth metal oxide, sulfur dioxide, a metal phosphate glass, soot, or a combination thereof.

19. A gas sensor, comprising the ammonia gas sensor element of claim 1.

20. A method of making an ammonia gas sensor element, comprising:
disposing an ammonia selective sensor electrode on and in ionic communication with a solid electrolyte;
disposing a reference electrode on and in ionic communication with the solid electrolyte; and
disposing a protective layer comprising a porous portion comprising an ammonia-inert material on the ammonia selective sensor electrode.
